(19) United States
(12) Patent Application Publication
(10) Pub. No.: US 2025/0294375 A1
(43) Pub. Date: Sep. 18, 2025

(54) CONTROLLING THE COLLECTION OF DATA FOR USE IN TRAINING A MODEL

(71) Applicant: Telefonaktiebolaget LM Ericsson (publ), Stockholm (SE)

(72) Inventors: Pablo SOLDATI, Solna (SE); Euhanna GHADIMI, Bromma (SE)

(73) Assignee: Telefonaktiebolaget LM Ericsson (publ), Stockholm (SE)

(21) Appl. No.: 18/862,662

(22) PCT Filed: May 5, 2023
(86) PCT No.: PCT/EP2023/061900

§ 371 Date: Nov. 4, 2024

Related U.S. Application Data
(60) Provisional application No. 63/338,523, filed on May 5, 2022.

(51) Int. Cl. H04W 24/02; H04W 24/10

(52) U.S. Cl. CPC H04W 24/02; H04W 24/10

(57) ABSTRACT

A method performed by a first network node for configuring a second network node. The method includes transmitting to the second network node a first message for configuring the second network node with respect to the collection of at least first training data for use in producing (e.g., generating or updating) a first model, wherein the first message comprises first data collection configuration information that comprises (i. e., includes at least) one or more of: a first process identifier (e.g., link adaptation or power control) identifying a first process that uses the first model, a first model identifier identifying the first model, or a first model version identifier identifying a version of the first model.

### TECHNICAL FIELD

Disclosed are embodiments related to controlling the collection of data for use in training a model (e.g., a neural network or other model).

### BACKGROUND

### Radio Access Network (RAN) Intelligence

FIG. 1 illustrates the Functional Framework for RAN Intelligence. As shown in FIG. 1, the framework includes the following functions: 1) a data collection function; 2) a model training function; 3) a model inference function; and 4) an actor function, or Actor.

The data collection function provides training data to the model training function. Training data is data that is needed by the model training function to train a model (e.g., a neural network or other model). In Machine Learning (ML) (a.k.a., “Artificial Intelligence (AI)”) parlance, a model (e.g. a neural network) is defined as a functional approximation, whose parameters (e.g., neural network weights) are optimized to approximates a mathematical function, whose input-output behavior is characterized by a data set (i.e., the training set). In many Reinforcement Learning (RL) systems, the function approximated by the model is the Q-function, which assigns a value to a state-action pair. In turn, the Q-function (hence the ML model) determine the behavior (or policy) of the RL agent. The data collection function also provides inference data to the model inference function, which uses the inference data to produce an output (a.k.a., an inference).

ML algorithm specific data preparation (e.g., data pre-processing and cleaning, formatting, and transformation) may also be carried out in the data collection function. Examples of interference and training data may include measurements from user equipments (UEs) or different network entities, feedback from the Actor, and output from the model inference function.

The model training function performs the ML model training, validation, and testing which may generate model performance metrics as part of the model testing procedure. The model training function is also responsible for data preparation (e.g. data pre-processing and cleaning, formatting, and transformation) based on training data delivered by a data collection function, if required. The model training function deploys a trained, validated and tested model (e.g., a model that parameterizes or approximates at least one of a policy function, a value function and a Q-function in a deep reinforcement learning environment) to the model inference function or delivers an updated model to the model inference function.

The model inference function provides model inference output (e.g. predictions or decisions). The model inference function may provide model performance feedback to the model training function when applicable. The model inference function is also responsible for data preparation (e.g. data pre-processing and cleaning, formatting, and transformation) based on inference data delivered by a data collection function, if required. The model inference function may provide model performance feedback information to the model training function, which uses this feedback information for monitoring the performance of the model.

The actor is a function that receives the output from the model inference function and triggers or performs corresponding actions. The Actor may trigger actions directed to other entities or to itself. The actions may generate feedback information, provided to the data collection function, that may be needed to derive training or inference data.

Three use cases have been identified for RAN Intelligence: 1) Network Energy Saving, 2) Load Balancing, and 3) Mobility Optimization and the potential standard impacts. These are described in 3GPP Technical Report (TR) 37.817 v17.0.0 (hereafter “TR 37.817”)

For Network energy saving use case, TR 37.817 states:
The following solutions can be considered for supporting AI/ML-based network energy saving:
1. AI/ML Model Training is located in the OAM and AI/ML Model Inference is located in the gNB [5G base station].
2. AI/ML Model Training and AI/ML Model Inference are both located in the gNB. Note: gNB is also allowed to continue model training based on model trained in the OAM.

In case of CU-DU split architecture, the following solutions are possible:
3. AI/ML Model Training is located in the OAM and AI/ML Model Inference is located in the gNB-CU.
4. AI/ML Model Training and Model Inference are both located in the gNB-CU.

For Mobility Optimization use case, TR 37.817 states:
Considering the locations of AI/ML Model Training and AI/ML Model Inference for mobility solution, the following two options are considered:
   1. The AI/ML Model Training function is deployed in OAM, while the model inference function resides within the RAN node.
   2. Both the AI/ML Model Training function and the AI/ML Model Inference function reside within the RAN node.
   Furthermore, for CU-DU split scenario, following option is possible:
   3. AI/ML Model Training is located in CU-CP or OAM and AI/ML Model Inference function is located in CU-CP. Note: gNB is also allowed to continue model training based on model trained in the OAM.

For Load Balancing use case, TR 37.817 states:
The following solutions can be considered for supporting AI/ML-based load balancing:
1. AI/ML Model Training is located in the OAM and AI/ML Model Inference is located in the gNB.
2. AI/ML Model Training and AI/ML Model Inference are both located in the gNB.
In case of CU-DU split architecture, the following solutions are possible:
3. AI/ML Model Training is located in the OAM and AI/ML Model Inference is located in the gNB-CU.
4. AI/ML Model Training and Model Inference are both located in the gNB-CU.
Note: gNB is also allowed to continue model training based on model trained in the OAM.

Other possible locations of the AI/ML Model Inference are FFS.

3GPP Technical Docment (Tdoc) R3-215244 proposes to introduce a model management function in the Functional Framework for RAN Intelligence, as shown in FIG. 2. Tdoc R3-215244 states:
Model deployment/update should be decided by model management instead of model training. The model management may also host a model repository. The model deployment/update should be performed by model management.
Model performance monitoring is a key function to assist and control model inference. The model performance feedback from model inference should be first sent to model management. If the performance is not ideal, the model management may decide to fallback to traditional algorithm or change/update the model.
The model training should be also controlled by model management.
The model management function may be taken by either OAM or CU or other network entities depending on the use cases. Clearly defining a model management function is useful for future signalling design and analysis.
Proposal 1: Introduce a model management function into AI/ML framework [as shown in FIG. 2].
Model management function supports following roles: i) Requesting model training and receiving the model training result; ii) Model deployment/updates for inference, iii) Model performance monitoring, including receiving performance feedback from model inference and taking necessary action, e.g. keep the model, fallback to traditional algorithm, change or update the model, iv) Model storage.

### Training architectures for Reinforcement Learning (RL)

The main objective of model training is to produce a model (e.g., neural network that parameterizes or approximates at least one of a policy function, a value function and a Q-function) that can generalize to conditions and situations not directly experienced in the training data (i.e., a model that performs well when used with inference data that differs from the training data used in the training process). This process is also known as a training process.

Recent advances in the field of reinforcement learning (RL) have focused on techniques that could improve the quality of learning, learning efficiency (i.e., how much information can be extracted from a given training data set) and learning speed. Many of these techniques rely on advanced training architectures that exploit parallel and distributed collection of training data (a.k.a., “experience samples” or “experiences”), combined with either a centralized or distributed training process. In one embodiment, illustrated in FIG. 3, each “rollout worker” (i.e., a function that combines the functionality of the model inference function and the Actor function) receives a model update from a Model Training function. The rollout worker (e.g., an RL agent) uses the received model to interact with an external environment by selecting actions and applying the actions to the environment. In return, the rollout worker can collect experience samples that can be used for further training and improving the model. Typically, an experience sample is a tuple that comprises: i) an observation (e.g., state vector) for time step t (denoted St), ii) an action (At) selected based on St, iii) an observation for time step t+1 (denoted St+1), and iv) a reward value Rt based on St and St+1. Some techniques provide a shared storage memory, also known as “replay buffer” or “experience buffer,” in which the rollout workers store the experience samples (e.g., at each time step, the rollout worker generates and stores an experience in the replay buffer). The Model Trainer function can then sample experiences from the replay buffer to train/update the model (e.g., a new set of weights of a neural network), which is then provided to the distributed rollout workers.

Parallel and distributed experience sample collection allows the evaluation of multiple versions of a model in parallel and to quickly produce a new model. It also allows for improved diversity in the collected information, as different rollout workers can be tasked to test the model against different versions of the environment. This allows improved quality of the collected experiences, which in turns enables: producing a model that better generalizes against conditions (e.g., events) unseen during the training process, improving the speed of learning because updates of the model can be provided more frequently due to the high throughput of the training data generation, and improving learning efficiency (i.e., the improved data diversity provided by parallel and distributed rollout workers enables production of a better model for a given amount of experience samples compared to the case where a single rollout worker is used). Using these techniques in a RAN could achieve a performance that otherwise would not be possible to achieve.

### SUMMARY

Certain challenges presently exist. For instance, a direct application of conventional RL model training to a RAN or other communication networks is not possible. On one hand, the conventional technology has been developed for training RL models in software environment, in which the model training function and rollout workers often run in co-located hardware, where latency between these functions is not an issue. This allows to quickly produce a new model update with small batches of training data (typically a few hundred experience samples) and to immediately provide the new model to the rollout workers. But in a RAN, such as a 3GPP E-UTRAN or 3GPP

NR RAN, this is not possible. Depending on the network node hosting the trainer and the rollout workers, a different level of latency can be experienced (from several tens of milliseconds to seconds or minutes). For example, the trainer could be in a Service Management and Orchestration (SMO) node or an Operation and Maintenance (OAM) node, while the rollout workers could be located in a base station (e.g., in a distributed unit (DU) of a 5G base station (gNB) (denoted gNB-DU)). In other situations, the trainer could be located outside the RAN or even outside the network operator's network, as would be the case when the operator's vendor retains control and responsibility for training and re-training models and polices deployed in its product.

Another problem that affects the frequency at which an updated model can be deployed to the rollout workers in a RAN is the way such update is provided. To avoid exposing the model information to third parties, updating a model may require a software patch to be delivered to the rollout workers, which is an operation done infrequently in RANs. Such mechanism would not be applicable for advanced training architectures applied to RANs as model updates typically happens at high frequency at rollout workers.

Another problem is related to the amount and quality of the training data that can be produced in a RAN. Most applications of these domains operate at a fast time scale. For instance, 3GPP E-UTRAN and NR systems allow scheduling of transitions on a millisecond granularity. Many operations related to the physical access (PHY) layer and medium access (MAC) layer, that could be controlled by an RL agent, could produce experience samples on a millisecond basis (e.g., for link adaptation, power control, resource and user scheduling, information encoding and decoding, etc.), while other network operations residing at higher layers of the networking protocol stack could generate experience samples in a slower time scales (from tens to hundreds of milliseconds, or in some case sub-second time-scales). This can therefore result in an overwhelming amount of training data produced by each individual rollout worker every second. For example, in the case an outer loop link adaptation (OLA) function that employ an RL agent to control the link adaptation in the radio cells, one could expect hundreds to thousands of experience samples per seconds for each radio cell. Thus, in a network consisting of thousands of radio cells, one could expect millions of experience samples to be produced every second and delivered to the shared memory (i.e., the reply buffer). This would prevent the production of a good model for two reasons. First, a model update typically requires a few hundred samples, and one could not support hundreds of model updates per second in a RAN due to the latency issues earlier discussed. Second, several experience samples collected by each rollout worker, for instance, experience samples collected in a cell for a given user within a short period of time (e.g., within a second), are typically very similar to one another or at least very correlated. Thus, each rollout worker (e.g., radio cell) would contribute to the replay buffer with experience samples that do not provide sufficient diversity for improving the model.

Accordingly, in one aspect there is provided a method performed by a first network node for configuring a second network node. The method includes transmitting to the second network node a first message for configuring the second network node with respect to the collection of at least first training data for use in producing (e.g., generating or updating) a first model, wherein the first message comprises first data collection configuration information that comprises (i.e., includes at least) one or more of: a first process identifier (e.g., link adaptation or power control) identifying a first process that uses the first model, a first model identifier identifying the first model, or a first model version identifier identifying a version of the first model.

In another one aspect there is provided a method performed by a second network node. The method includes receiving from the first network node a first message for configuring the second network node with respect to the collection of at least first training data for use in producing (e.g., generating or updating) a first model, wherein the first message comprises first data collection configuration information that comprises (i.e., includes at least) one or more of: a first process identifier (e.g., link adaptation or power control) identifying a first process that uses the first model, a first model identifier identifying the first model, or a first model version identifier identifying a version of the first model.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium. In another aspect there is provided a network node that is configured to perform the methods disclosed herein. The network node may include memory and processing circuitry coupled to the memory.

An advantage of the embodiments disclosed herein is that they enable efficient and scalable training data collection from a plurality of rollout workers. Another advantage of the embodiments is that they enable improved diversity in the training data set gathered for a certain function or process (a.k.a., algorithm), such as an outer loop link adaptation function (OLAF) or a power management function (PMF), that employs a rollout worker because a plurality of network nodes can be configured to collect experience samples providing different information of the overall data distribution (e.g., different load conditions, different inference conditions, different user quality of service requirements, etc). This can provide improved generalization when training, updating, re-training or modifying a model used by a function deployed in a plurality of network nodes. In turn, this allows to better optimize the operation (e.g., link adaptations, power management, etc.) controlled by the model and thereby improve the overall system performance.

### BRIEF DESCRIPTION OF THE DRAWINGS

The accompanying drawings, which are incorporated herein and form part of the specification, illustrate various embodiments.

FIG. 1 illustrates a Functional Framework for RAN Intelligence.

FIG. 2 illustrates the introduction of a model management function in the Functional Framework for RAN Intelligence.

FIG. 3 illustrates a training architecture exploiting distributed collection of experience samples.

FIG. 4 illustrates a system according to an embodiment.

FIG. 5A is a message flow diagram according to an embodiment.

FIG. 5B is a message flow diagram according to an embodiment.

FIG. 6 illustrates an embodiment where only some training data samples are collected according to a received data collection configuration

FIG. 7 illustrates an embodiment in which a first network node configures a second network node to collect training data associated to a first process in a first interval of time and not to collect training data in a second interval of time.

FIG. 8 illustrates an embodiment in which the data collection configuration indicates that at least a number of training data samples should be collected during one or more first time intervals.

FIG. 9 illustrates an embodiment where a second network node is configured to collect training data in a first time interval according to a model.

FIG. 10 illustrates an embodiment in which the data collection configuration further configures a second network node to use a second process during a second interval of time.

FIG. 11 is a flowchart illustrating a process according to an embodiment.

FIG. 12 is a flowchart illustrating a process according to an embodiment.

FIG. 13 is a block diagram of a network node according to an embodiment.

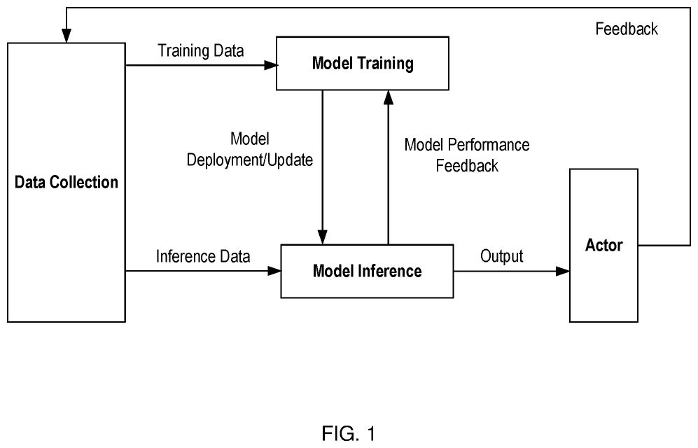

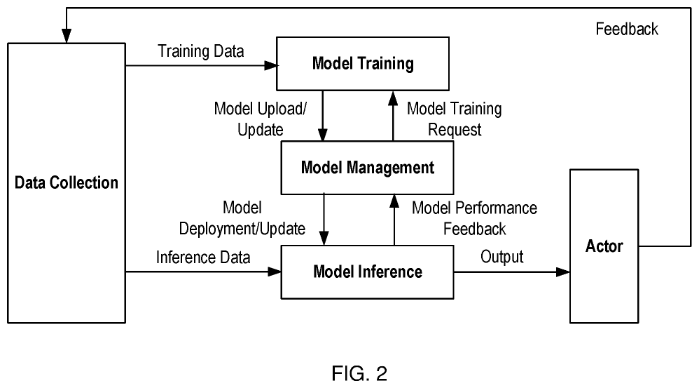

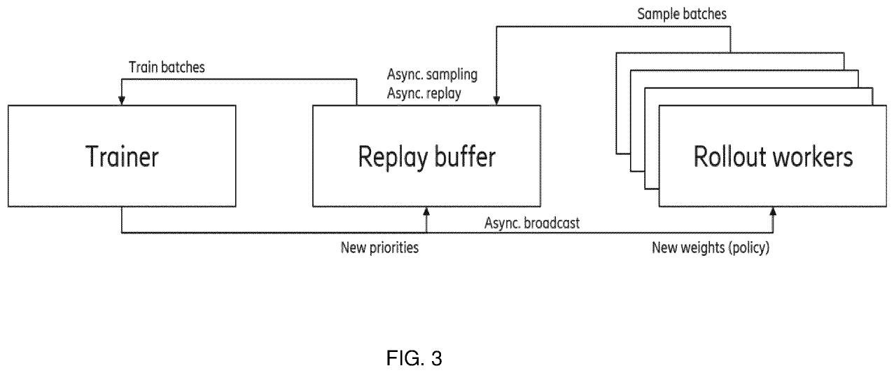

### DETAILED DESCRIPTION

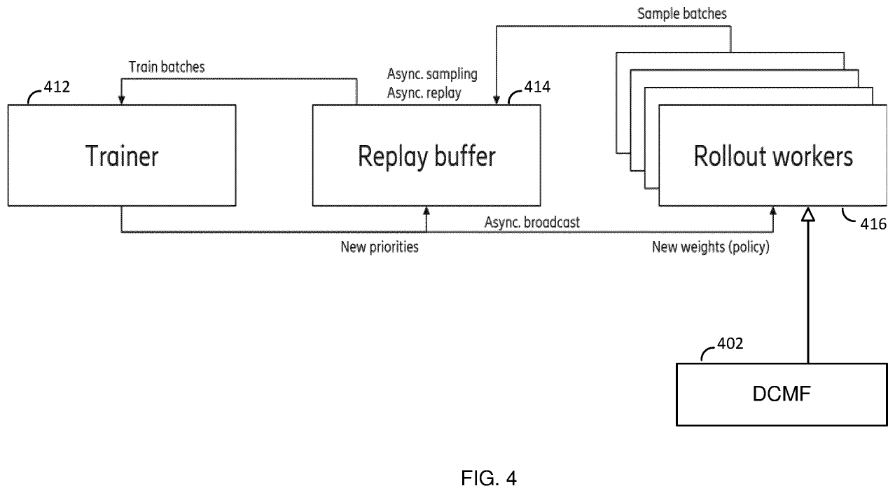

FIG. 4 illustrates a system 400 according to an embodiment. System 400 includes a model training function 412 (“trainer”), a replay buffer 414, and a set of one or more rollout workers, including at least a first rollout worker 416. As noted above, a challenge presently exists due to the amount of training data (e.g., experience samples) that gets produced by the rollout workers, such as, for example, an RL agent that is employed by an OLA function to set one or more link adaptation parameters, or an RL agent employed by a PMF that sets one or more power management parameters.

To resolve this issue, this disclosure provides a data collection management function (DCMF) 402 that is configured to control, enable or disable discontinuous collection of training data, which can be used by trainer 412 to train a model that is used by one or more rollout workers where an inference function resides (e.g., an entity, such as a RL agent or a ML agent using supervised machine learning where the trained model is used for inference) using a training process, which requires training data (a.k.a., training dataset). The training process for a model, such as a neural network, comprises optimizing the model's parameters (e.g., the neural network weights associated to the connections between different layers of the neural network) to fit the distribution of the training dataset. During this training process, the model's parameters can be gradually and iteratively updated by evaluating a loss function over the training dataset. In each training iteration, the model parameters can be updated or optimized by means, for instance of a gradient method, e.g., by computing a gradient or a sub-gradient of the loss function with respect to the model parameters at each iteration of the training process. The model parameters can then be updated based on the computed gradient or sub-gradient. In some cases, a trained model can be re-trained or updated by restarting the training process and possibly using new training data to further update the model parameters. The terms model training, model optimizing, model optimization, model updating are herein used interchangeably with the same meaning unless explicitly specified otherwise.

Advantageously, DCMF 402 transmits towards a network node (hereinafter referred to as the “second network node”) a configuration message with configuration information relating to the collection of experience samples in a discontinuous manner. The second network node may utilize a model for the controlling or executing at least one network functionality (e.g., OLA, power management, etc.) (i.e., the second network node may execute one or more rollout workers) or the second network node may control another network node that utilizes such a model. In some embodiments, the configuration provided by DCMF 402 may include instructions or recommendations in relation to, when, how, for how long, how frequently, how many experience samples should be collected in relation to a network function or model (or version thereof).

The configuration provided by DCMF 402 may further provide information requesting or instructing or configuring the second network node to report experience samples collected in relation to a network function or model (or version thereof).

The methods disclosed herein are independent with respect to specific AI/ML model types or learning problems/setting (e.g. supervised learning, unsupervised learning, reinforcement learning, hybrid learning, centralized learning, federated learning, distributed learning, . . . ). Non limiting examples of AI/ML algorithms may include supervised learning algorithms, deep learning algorithms, reinforcement learning type of algorithms (such as DQN, A2C, A3C, etc.), contextual multi-armed bandit algorithms, autoregression algorithms, etc., or combinations thereof. Such algorithms may exploit functional approximation models, hereafter referred to as AI/ML models, such as neural networks (e.g. feedforward neural networks, deep neural networks, recurrent neural networks, convolutional neural networks, etc.). Examples of reinforcement learning algorithms may include deep reinforcement learning (such as deep Q-network (DQN), proximal policy optimization (PPO), double Q-learning), actor-critic algorithms (such as Advantage actor-critic algorithms, e.g. A2C or A3C, actor-critic with experience replay, etc), policy gradient algorithms, off-policy learning algorithms, etc.

### 1. Method Performed by a First Network Node

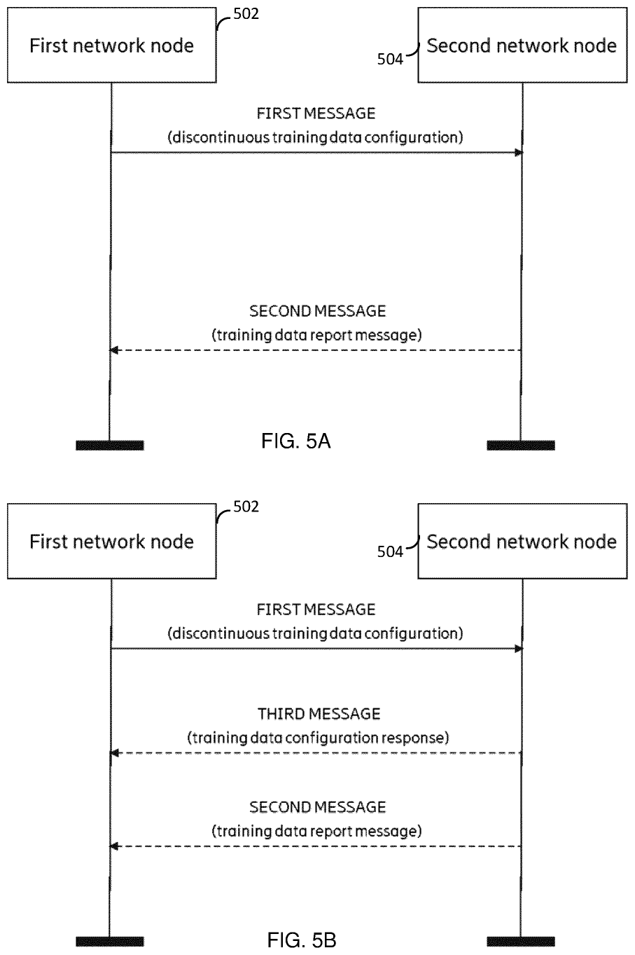

This disclosure describes a method performed by a first network node 502 (see, e.g., FIG. 5A) in a communication network (e.g., a RAN) to control the collection of training data produced by an process (a.k.a., function or algorithm), such as a link adaptation process or power management process, that runs in a network node of the communication network. The process could be any one of: a downlink link adaptation (DLLA) process, an open loop link adaptation (OLA) process (a.k.a., OLAF), an energy efficiency process, a handover process, a mobility optimization process, a mobility load balancing process, a channel state information reporting process, a channel state information compression process, a power control process, a coverage and capacity optimization process, a transmission mode optimization process, a scheduling process, or other process used in a communication network. The method is illustrated in FIG. 5A, and comprises at least one of:

1) the first network node 502 transmitting to a second network node 504 (e.g., a RAN network node, a core network (CN) network node, a UE, etc.) a first message (a.k.a., “configuration message”) comprising a data collection configuration associated to a first process of the second network node, wherein the first process uses a model to achieve its function. The first network node may generate the configuration (e.g., the first network node may execute DCMF 402, which generates the configuration information) or the first network node may obtain the configuration information from another network node that executes DCMF 402.

2) the first network node receiving a second message transmitted by the second network node, the second message comprising a training data report associated to the first process. The second network node may generate the training data report (e.g., the second network node may execute the first process itself) or the second network node may obtain the training data report from another network node that generates the training data report.

In some embodiments, the first network node receives the second message from the second network node without transmitting the first message to the second network node.

In some embodiments, the first message may be considered as a subscription for gathering training data from a second network node. As such, in its simplest form, the first message may comprise just a request for training data, while in other examples the first message may provide instructions or recommendations for the second network node for discontinuous training data collection associated to a first process of the second network node.

In another embodiment, illustrated in FIG. 5B, the first network node may additionally receive a third message transmitted by the second network node indicating whether the data collection configuration associated to a first process of the second network node is successfully configured/accepted or not.

It should be noticed that when the third message is received in response to the transmission of first message, the first network node may in some embodiments receive the third message prior to receiving the second message comprising the training data report. In one embodiment where the third message indicate a failure to configure a discontinuous training data collection at the second network node, the first network node may not receive a second message.

### 1.1 Embodiments Related to the First Message

### 1.1.1. Configuration for Discontinuous Training Data Collection

In one embodiment, the configuration for discontinuous training data collection (or “data collection configuration” for short) provided by the first network node may indicate one or more of:
1. One or more second network node identities to which the configuration is addressed to
2. One or more radio cell identities to which the configuration is associated to or should be applied to
3. One or more process identity to which the configuration is associated to or for which training data collection is configured or requested
4. One or more model identity to which the configuration is associated to or for which training data collection is configured or required
5. One or more model version to which the configuration is associated to or for which training data collection is configured or required
6. One or more inference function identity to which the configuration is associated to or for which training data collection is configured or required
7. One or more actor identity to which the configuration is associated to or for which training data collection is configured or required
8. One or more rollout worker identity to which the configuration is associated to or for which training data collection is configured or required

Therefore, the first message may indicate a specific model as well as the model version for which training data collection is required or configured. In one embodiment, the model identity and/or the model version, and/or the process identity may uniquely identify a model in the Public Land Mobile Network (PLMN) to which the configuration for distributed training data is associated and for the second network node is configured, instructed or recommended to provide training data. In other words, the first message may indicate to the second network node which model and/or which model version and/or which process should be used to collect training data according to the data collection configuration provided by the first network node.

In one embodiment, first message may further comprise:
1. A model to be used for training data collection
2. An indication or an identifier of an process, such as the first process, to which the model is associated to or used for
3. An identity and/or version of the model to be used with the first process
4. An indication of an exploration strategy to be used for discontinuous training data collection with
5. One or more configuration parameters associated to the indicated exploration strategy to be used for discontinuous training data collection

The first network node may therefore provide to the second network node a model, such as an updated version of a model previously used by the second network node, and an indication of the process (e.g., OLAF or PMF) to which such model is associated. In one example, the model provided by the first network node to the second network node may represent an updated behavioral policy for a process used by the second network node. The model could further be uniquely identified by a model identity and/or a model version. This enables the second network node to distinguish among different version of a model, and to collect training data in association to a specific model and/or to a specific model version.

The first message may additionally configure the second network node for discontinuous training data collection by indicating that:
1) Experience samples should be collected using the first process with a model provided by the first message;

2) Experience samples should be collected using the first process with a model identified by one or more of i) a model identity indicated by the first message or ii) a model version indicated by the first message;
3) Training data should be collected using the first process with a model and an exploration policy indicated by the first message, where the model could be identified by one or more of i) a model identity indicated by the first message or ii) a model version indicated by the first message.

In one embodiment, the data collection configuration provided by the first network node may indicate one or more of:
1. A starting time for discontinuous training data collection
2. An ending time for discontinuous training data collection
3. A time duration over which discontinuous training data collection is enabled
4. A repetition patter for discontinuous training data collection
5. A periodicity pattern for discontinuous training data collection
6. At least one triggering condition (e.g., the detection of a certain event or other condition) to be fulfilled for initiating the discontinuous training data collection
7. At least one triggering condition to be fulfilled for terminating the discontinuous training data collection.

The first network node may therefore provide information related to when to initiate the training data collection, such as a starting time or conditions to be fulfilled to start collecting training data, and how to collect the training data.

Examples of triggering conditions to be fulfilled for initiating the discontinuous training data collection may include scenarios based on:
1) Information related to new network deployment, such as e.g. addition of new cells, deletion of existing network cells or reconfiguration of one or more existing network cell(s), or network parameters that have not been used previously for training (e.g., new carrier frequencies, uplink-downlink time-frame pattern configuration in TDD communication, inter-site distance, antenna configuration etc.);
2) Events defined in relation to some radio access network KPIs change such as thresholds defined with respect to network throughput, statistics on spectral efficiency, latency, packet reliability and/or other QoS metrics; and/or
3) Events defined in relation to certain learning metrics such as thresholds defined on observed outputs (observed statistical functions e.g., average, variance etc.) of the AI/ML models, rewards, value functions (e.g., Q-value) and/or discrepancy between value functions and measured reward signal (e.g., the Time Difference error defined in the context of RL).

In one embodiment, the triggering condition to be fulfilled for terminating the training data collection is the reception, at the second network node, of a new first message (i.e., a new configuration message) from the first network node providing a new data collection configuration. In an embodiment, the second network node could be configured for discontinuous training data collection in association to a model (e.g., identified by an identity and/or a version identifier, as per other embodiments), and to continue following the configuration until a new or an updated a model is received from the first network node.

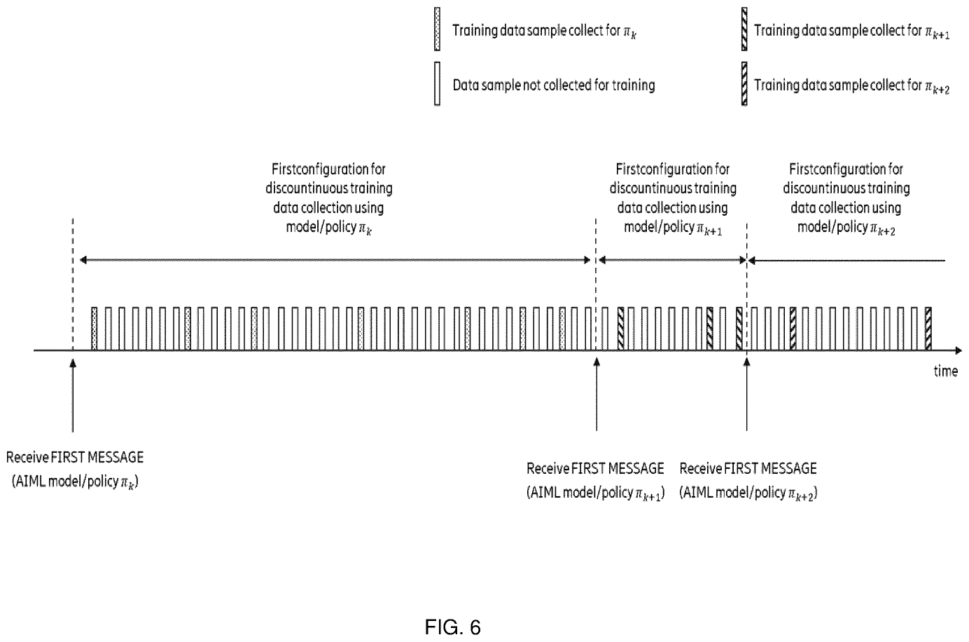

FIG. 6 illustrates an embodiment where only some training data samples (e.g., experiences) are collected according to a received data collection configuration until a new configuration is received.

In one embodiment, the data collection configuration provided by the first network node may indicate one or more information related to how many training data samples are required, instructed, or recommended to be collected, such as:
1. A number N of training data samples to be collected
2. A minimum number Nₘᵢₙ of training data samples to be collected
3. A maximum number Nₘₐₓ of training data samples to be collected
4. A range of number of training data samples to be collected
5. A number Nₑ of training data episodes, wherein each training data episode may consist of multiple training data samples
6. A minimum number N_{e,min} of training data episodes to be collected
7. A maximum number N_{e,max} of training data episodes to be collected
8. A range of number of training data episodes to be collected.

Therefore, in one embodiment the first network node may configure the second network node to collect a certain number of training data samples discontinuously without specifying an interval of time where the discontinuous training data collection should be carried out. In one embodiment, the data collection configuration may indicate how many training data samples the second network node are required, instructed, or recommended to collect in association to a model. FIG. 6 shows an embodiment where the second network node receive different first messages providing different requirements or recommendations on the number of training data samples that can be collected until a new configuration is provided by the first network node.

In some examples, the first network node may configure the second network node to collect a certain number of training data episodes discontinuously without specifying an interval of time where the discontinuous training data collection should be carried out. Each training data episode may consist of a sequence of training data samples, which may be collected in continuous or discontinuous manner. Thus, the data collection configuration may further provide one or more information in the group of: i) a fixed length of the episode, for instance expressed as a number of training data samples to be collected per episode; ii) a terminal condition to be fulfilled to terminate the data collection for each episode.

In one embodiment, the data collection configuration provided by the first network node may indicate one or more of: i) at least one first interval of time wherein the second network node is configured to collect at least training data associated to the use of the first process; or ii) at least one second interval of time wherein the second network node is configured not to collect any training data associated to the use of the first process. In one example, the data collection configuration may indicate to enable training data collection associated to the first process or the first model is enabled in the first time interval, and/or to disable the collection of training data associated to the use of the first process during the second time interval.

Therefore, the data collection configuration may indicate that training data collection could occur in one or multiple first-time intervals separated in time, where between two consecutive first time intervals the second network node are configured not to collect training data associated to the first process. When the first message indicates more than one first intervals of time or more than one second intervals of time, the first message may additionally provide or indicate intervals of time of different duration.

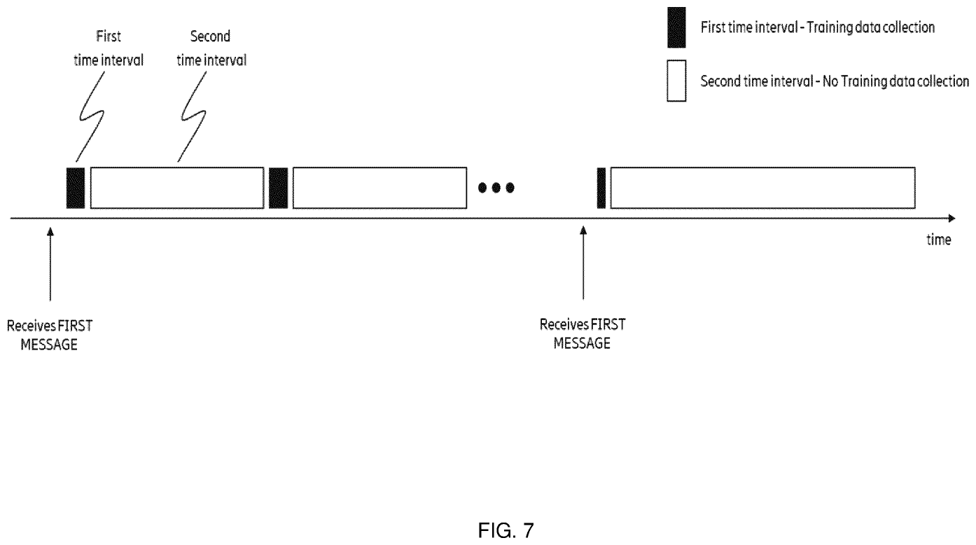

FIG. 7 illustrates an embodiment in which the first network node configures the second network node to collect training data associated to a first process in a first interval of time (in black) and not to collect training data in a second interval of time (in white).

In combination with other embodiments, the first message may therefore provide instructions or recommendations to configure different patterns of first interval and second interval for enabling discontinuous training data collection. In another embodiment, the first message may provide instructions to configure periodic repetitions of a first interval and a second interval for discontinuous training data collection. In yet another embodiment, the first message may provide triggering conditions to initiate and/or terminate discontinuous training data collection based on different patterns of first interval and second interval, possibly repeated over time with a certain periodicity. In another embodiment, the first message may provide instructions or recommendations to configure different discontinuous training data collection of a given number of training data samples.

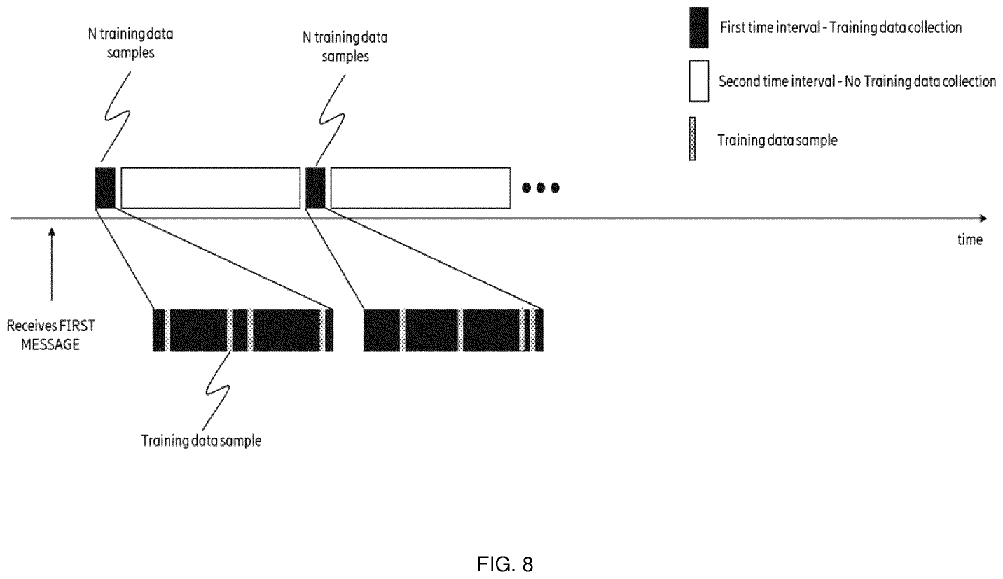

In one embodiment, illustrated in FIG. 8, the data collection configuration may further indicate that at least a number of training data samples should be collected during one or more first time intervals indicated by the first message. More specifically, FIG. 8 shows an embodiment where an equal number N (N≥1) of training data samples are configured to be collected over the duration of K first time intervals (K≥1).

In one embodiment, the first message may configure the second network node to collect an equal number of N≥1 training data over the duration of K≥1 first time intervals, thereby requiring N. K training data.

In one embodiment, the first message may configure the second network node to collect different numbers of Nₖ≥1 training data in each of K≥1 first time intervals.

In one embodiment, the first message may configure the second network node to collect N≥1 training data over the duration of K≥1 first time intervals, without specifying the number of training data samples to be collected in each first interval of time.

The data collection configuration may additionally indicate one or more data collection patterns to be used for collecting training data within each of one or more first time intervals. In one embodiment, training data samples are configured to be collected equally spaced in time during the duration of the first time interval. In another embodiment, training data samples are configured to be collected if one or more conditions are fulfilled during the first time interval.

Therefore, in combination with other embodiments, the second network node could be configured for discontinuous training data collection so that training data samples are collected during a first time interval, indicated by the first message, using the first process configured with a model as well as an exploration policy, which could also be provided or indicated by the first message.

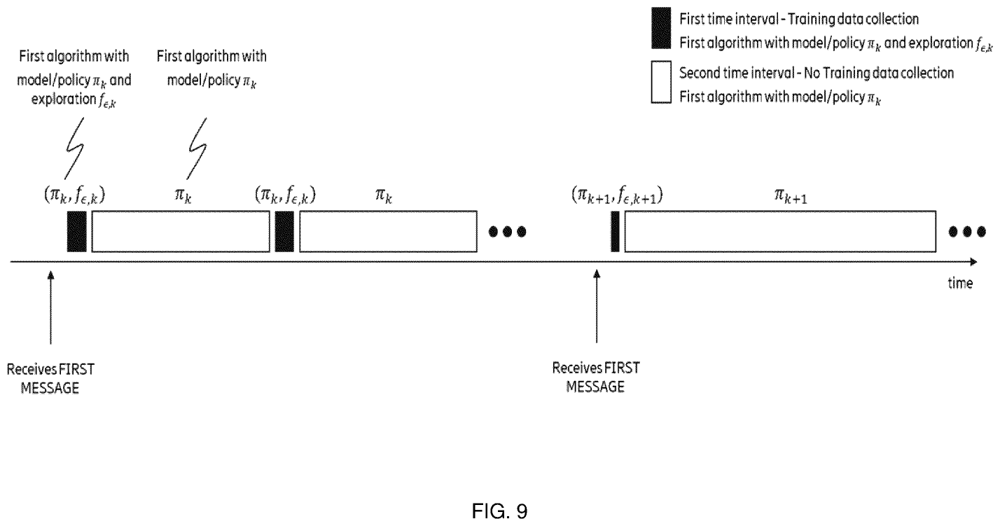

FIG. 9 illustrates an embodiment where the second network node is configured to collect training data in a first time interval according to a model indicated by πₖ, where the sub-script k indicates the model version, and an exploration function f_{ϵ,k}, where the subscript e indicates a set of hyperparameters of the exploration function and the subscript k indicates the model version with which the exploration strategy should be used. In this example, the second network node is further configured to use the first process in a second time interval according to model πₖ, where it is instructed or recommended not to collect any training data.

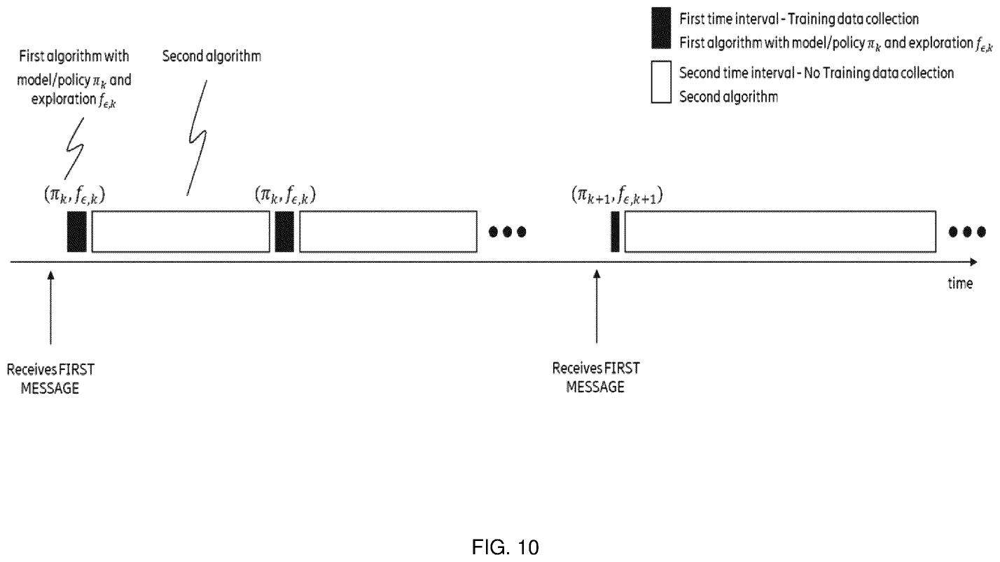

In one embodiment, illustrated in FIG. 10, the data collection configuration may further configure, indicate or recommend the second network node to use a second process during the second interval of time, for which the second network node is not configured to collect training data. Therefore, the data collection configuration may further comprise a second process identifier identifying a second process to be used during the second interval of time. Additionally, the data collection configuration may further comprise an indication that training data collection should be disabled during the second interval of time and/or for the second process.

In one embodiment, the second process is a second ML based process that employs a second model. In this case, the data collection configuration may further comprise a second model identifier identifying the second model, or a second model version identifier identifying a version of the second model. For example, the second process could consist of the first process using a second model, such as an older version of the first model used by the first process (i.e., a previously trained version of the first model). In one embodiment, the second process is a not based on ML, i.e. the second process may not be using or be based on any ML model.

Accordingly, the first network node may use the data collection configuration to configure the second network node to alternate between the use of a first ML based process and a second process for a certain radio or network functionality. According to embodiments, the first process uses a model and is configured to be used for training data collection, while the second process is configured to be used for normal operation of the second network node, for which training data collection is disabled. This has the advantage of efficiently collecting training data and of ensuring good performance of the second network node during the discontinuous training data collection process. In fact, the second process could be a non-ML based process known to provide acceptable performance, or an ML-based process known to provide an acceptable performance, which could be further improved with additional training data.

In one embodiment, the second network node may be configured to use the first process for downlink link adaptation (DLLA) operation based on a model It. The data collection configuration provided with the first message could provide, or configure or recommend the second network node to use a second process for DLLA, such as an outer loop link adaptation (OLLA) process when the second network node is configured to not collect training data, such as during the second interval of time indicated by the first message.

In another embodiment, the second network node may be configured to use the first process for handover operation of UEs based on a model It. The data collection configuration provided with the first message could provide, or configure or recommend the second network node to use a second process for handover operation based on a hysteresis process or one or more signal quality thresholds.

### 1.1.2 Configuration for Reporting Training Data Collection

In one embodiment, the data collection configuration provided by the first network node to the second network node may indicate a configuration for reporting training data (i.e., a reporting configuration). The reporting configuration may indicate one or more information in the group of:
1. The identity of at least a second network node to which the training data report should be provided, such as the first network node or a third network node. The third network node, in one embodiment, could be the host of a memory storage shared for collecting training data from multiple second network nodes.
2. An indication of the type of reporting, such as periodic reporting, one-time reporting, event-based or event-triggered reporting
3. For periodic reporting, the frequency or periodicity of the reporting
4. A starting time to initiate reporting of training data
5. A maximum number of training data samples to be reported for each reporting instance
6. A minimum number of training data samples to be reported in each reporting instance
7. At least one triggering condition to be fulfilled to initiate the reporting of training data. Non limiting examples of triggering conditions to initiate the reporting of training data may include one or more of:
   a) A maximum number of training data samples collected
   b) A minimum number of training data samples collected
   c) A maximum waiting time for reporting training data.

In one embodiment, the reporting configuration may require that one or more of the following information to be added to the training data report or to the format of individual training data provided within a training data report:
1. The identity of the second network node that generated the training data
2. The identity of the UE that generated the training data
3. The identity of the radio cell wherein training data samples are collected
4. An indication of the radio or network functionalities to which the reported training data samples are associated to
5. An indication or an identity of the process used to generate the reported training data
6. An indication or an identity of the model used to generate the reported training data
7. An indication the model version used to generate the reported training data
8. An indication of the inference function identity used to generate the reported training data
9. An indication of the actor identity used to generate the reported training data
10. An indication of the rollout worker identity used to generate the reported training data
11. An indication of at least a condition that initiated the discontinuous training data collection. In some example, the reported condition could be at least one of the conditions indicated by the first message to be fulfilled to initiate the discontinuous training data collection process.
12. An indication of at least a condition that terminated the discontinuous training data collection. In some example, the reported condition could be at least one of the conditions indicated by the first message to be fulfilled to terminate the discontinuous training data collection process.

In one embodiment, upon receiving a second message from the second network node comprising an indication of at least condition that initiated and/or terminated the discontinuous training data collection at the second network node, respectively, the first network node may determine to trigger a data collection configuration in another second network node.

### 1.2 Embodiments of the Second Message

In one embodiment, the first network node receives the second message from the second network node, with the second message comprising a training data report with training data (e.g., experience samples) collected and formatted based on the data collection configuration provided by the first network node.

Thus, according to different embodiments, the training data report received by the first network node may comprise a number of training data samples collected and formatted based on a data collection configuration provided by the first network node to the second network node in configuration message (i.e. a “first” message).

In one embodiment, the training data report may further comprise one or more information in the group of:
1. The identity of the second network node that generated the training data
2. The identity of the radio cell that generated the training data
3. An indication of the radio or network functionalities to which the reported training data samples are associated to
4. An indication or an identity of the process that was used to generate the reported training data
5. An indication or an identity of the model that was used to generate the reported training data
6. An indication the model version that was used to generate the reported training data.

### 2. Method in Second Network Node

This disclosure also discloses a method executed by a second network node in a radio communication network to control the collection of training data collection with respect to an process deployed or used by the second network node. The method comprises one or more of: i) receiving a first message from a first network node, the first message comprising a data collection configuration associated to a first process of the second network node, wherein the first process uses a model; and/or 2) transmitting a second message to the first network node or to a third network node, the second message comprising a training data report associated to the first process of the second network node.

In one embodiment, the second network node may generate a training data report based on a reporting configuration included in a configuration message (a.k.a., “first” message) from the first network node. According to other embodiments, the reporting configuration for reporting training data may provide instructions or recommendations for training data collection, training data formatting, and for the transmission of the training data report to the first network node.

In one embodiment, the first message may indicate that the second network node should send the second message to a third network node. The third network node, in one embodiment, could be the host of a memory storage shared for collecting training data from multiple second network nodes.

### 2.1 Embodiments Related to the Third Message

In one embodiment, the second network node may additionally transmit a third message to the first network node indicating whether the data collection configuration associated to a first process of the second network node is successfully configured/accepted or not.

In one embodiment, the third message may acknowledge that the second network node has been successfully configured to collect training data according to the configuration provided by the first message. In another embodiment, the third message provides a partial acknowledgement indicating that the second network node could successfully configure only one or more parts of the configuration provided by the first message. In this case, the third message may additionally indicate which parts of the configuration provided by the first network node could be used/configured by the second network node and/or which parts could not be used/configured by the second network node. In another embodiment, the third message may indicate a failure to configure at least one or all parts of the configuration provided by the first message. In this case, the third message may further indicate one or more cause for the failure.

### 2.2 Mapping to Existing Signaling Procedures

When the first network node interacts with a second network node, the first, second, and third messages may be implemented with a signaling procedure dedicated to configuring the second network node for discontinuous training data collection, or by reusing existing signals and procedures of, for instance, a 3GPP E-UTRAN or a 3GPP NG-RAN system.

Depending on the type of nodes used for the first network node and the second network node, as indicated in examples described in section 4 below, at least part of the content of the first message or the second message or the third message can be signaled over an interface between the first and the second network node. Non-limiting examples of possible interfaces may include X2/Xn, F1, E1, NG, S1 interfaces of a 3GPP LTE or NG-RAN system. Examples of possible types of first network node and second network node are described in section 4.

In one embodiment, the first message or the second message or the third message may reuse existing messages, such as an RRC message. For instance, the second message can be realized by extending an existing message, such as an RRCReconfigurationComplete message, an XnAP ACCESS AND MOBILITY INFORMATION, an XnAP HANDOVER REPORT, an XnAP RRC TRANSFER, an XnAP HANDOVER REQUEST or in a new message.

In another embodiment, with an NG-RAN node in split architecture, the first network node can be a gNB-CU-CP, the second network node can be gNB-DU, and the second message can be realized by extending an existing message, such as an F1AP UL RRC MESSAGE TRANSFER, an F1AP UE CONTEXT SETUP RESPONSE, an F1AP UE CONTEXT MODIFICATION RESPONSE, an F1AP UE CONTEXT MODIFICATION REQUIRED, an F1AP UE CONTEXT SETUP REQUEST, an F1AP UE CONTEXT MODIFICATION REQUEST, or in a new message.

### 3. Method in a UE

As noted above, second network node 504 may be a UE. Accordingly, this disclosure provides a method executed by UE in a radio communication network to control the collection of training data from the UE in connection with at least an process deployed or used by the UE. The method comprising one or more steps of: 1) receiving a first message from a first network node, the first message comprising a data collection configuration associated to a first process of the UE, wherein the first process uses a model; and/or 2) transmitting a second message to the first network node or to a third network node, the second message comprising a training data report associated to the first process of UE.

In one embodiment, the first message may indicate that the UE should send the second message to a third network node. The third network node, in one embodiment, could be the host of a memory storage shared for collecting training data from multiple second network nodes. In one embodiment, the UE may determine a training data report based on a configuration for reporting training data received with a first message from the first network node. According to other embodiments, the configuration for reporting training data may provide instructions or recommendations for training data collection, training data formatting, and for the transmission of the training data report to the first network node with a second message.

In one embodiment, the UE may additionally transmit a third message from the first network node indicating whether the data collection configuration associated to a first process of the UE is successfully configured/accepted or not.

In one embodiment, the third message may acknowledge that the UE has been successfully configured to collect training data according to the configuration provided by the first message. In another embodiment, the third message provides a partial acknowledgement indicating that the UE could successfully configure only one or more parts of the configuration provided by the first message. In this case, the third message may additionally indicate which parts of the configuration provided by the first network node could be used/configured by the UE and/or which parts could not be used/configured by the UE. In another embodiment, the third message may indicate a failure to configure at least one or all parts of the configuration provided by the first message. In this case, the third message may further indicate one or more cause for the failure.

### 3.1 Mapping to Existing Signaling Procedures

When the first network node interacts with a UE, the first, second, and third messages may be implemented with a signaling procedure dedicated to configuring the UE for discontinuous training data collection, or by reusing existing signals and procedures of, for instance, a 3GPP E-UTRAN or a 3GPP NG-RAN system.

In one embodiment, the first message or the second message can be realized by extending an existing RRC messages, such as an RRCReconfiguration message, or in a new message. In one embodiment, the first network node may receive from a UE a third message to indicate an acknowledge or a failure or a reject in response to the first message. In a possible implementation, the second message or the third message can be realized by extending the existing RRCReconfigurationComplete message, an RRC RRCReject message or in a new message. In one embodiment, the first network node can receive from a UE a second message comprising a training data report comprising, for instance, one or more training data samples, as originally requested by the first network node. In a possible implementation, a second message can be realized by extending the existing RRCReconfigurationComplete message, or in a new message.

### 4. Embodiments Related to First and Second Network Node Types and Architecture

The first network node and/or the second network node can be different RAN nodes (e.g. two gNBs, or two eNBs, or two en-gNBs, or two ng-eNBs). Additionally, The first network node and/or the second network node can be a UE.

The first network node and/or the second network node can be different nodes/functions of a same RAN node (e.g. a gNB-CU-CP and a gNB-DU, or a gNB-CU-CP and a gNB-CU-UP).

The first network node can be a RAN node (e.g. a gNBs, or a eNBs, or a en-gNBs, or a ng-eNBs) and the second network node can be component/nodes/functions of a second RAN node (e.g. gNB-CU-CP).

The first network node and/or the second network node can pertain to the same Radio Access Technology (e.g. e.g. E-UTRAN,, NG-RAN,, WiFi, etc.) or to different Radio Access Technologies (e.g. one to NR and the other to E-UTRAN or WiFi).

The first network node and/or the second network node can pertain to the same RAN system (e.g. E-UTRAN,, NG-RAN,, WiFi, etc) or to different RAN systems (e.g. one to NG-RAN and the other to E-UTRAN).

The first network node and the second network node may be connected via a direct signaling connection (e.g. two gNB via XnAP), or an indirect signaling connection (e.g. an e-NB and a gNB via S1AP, NGAP and one or more Core Second network nodes, e.g. an MME and an AMF).

The first network node can be a management system, such as the OAM system or the SMO, while the second network node can consist of a RAN node or function.

The first network node can be a RAN node or function while the second network node can be a management system, such as the OAM or the SMO.

The first network node can be a core second network node or function, such a 5GC function, while the second network node can consist of a RAN node or function.

The first network node can be a RAN node or function while the second network node can be a core second network node or function, such a 5GC function.

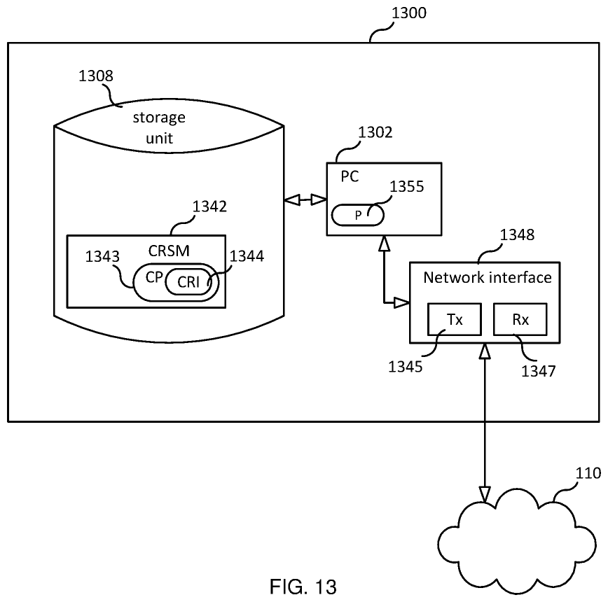

FIG. 13 is a block diagram of network node 1300, according to some embodiments, that can be used to implement first network node 504 or second network node 506. As shown in FIG. 13, network node 1300 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 1300 may be a distributed computing apparatus); at least one network interface 1348 (e.g., a physical interface or air interface) comprising a transmitter (Tx) 1345 and a receiver (Rx) 1347 for enabling network node 1300 to transmit data to and receive data from other nodes connected to a network 110 (e.g., an Internet Protocol (IP) network) to which network interface 1348 is connected (physically or wirelessly) (e.g., network interface 1348 may be coupled to an antenna arrangement comprising one or more antennas for enabling network node 1300 to wirelessly transmit/receive data); and a storage unit (a.k.a., “data storage system”) 1308, which may include one or more non-volatile storage devices and/or one or more volatile storage devices. In embodiments where PC 1302 includes a programmable processor, a computer readable storage medium (CRSM) 1342 may be provided. CRSM 1342 may store a computer program (CP) 1343 comprising computer readable instructions (CRI) 1344. CRSM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes network node 1300 to perform steps described herein (e.g., steps described herein with reference to the flow charts). In other embodiments, network node 1300 may be configured to perform steps described herein without the need for code. That is, for example, PC 1302 may consist merely of one or more ASICs. Hence, the features of the embodiments described herein may be implemented in hardware and/or software. According to embodiments, a network node may also be deployed or implemented as a function or logical entity of any kind, e.g. as a software entity implemented in a data center or a cloud, e.g. using one or more virtual machines.

According to embodiments, a network node may be a RAN node, an OAM, a Core Network node, an SMO, a Network Management System (NMS), a logic function in an Open RAN (O-RAN), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a UE.

### Summary of Various Embodiments

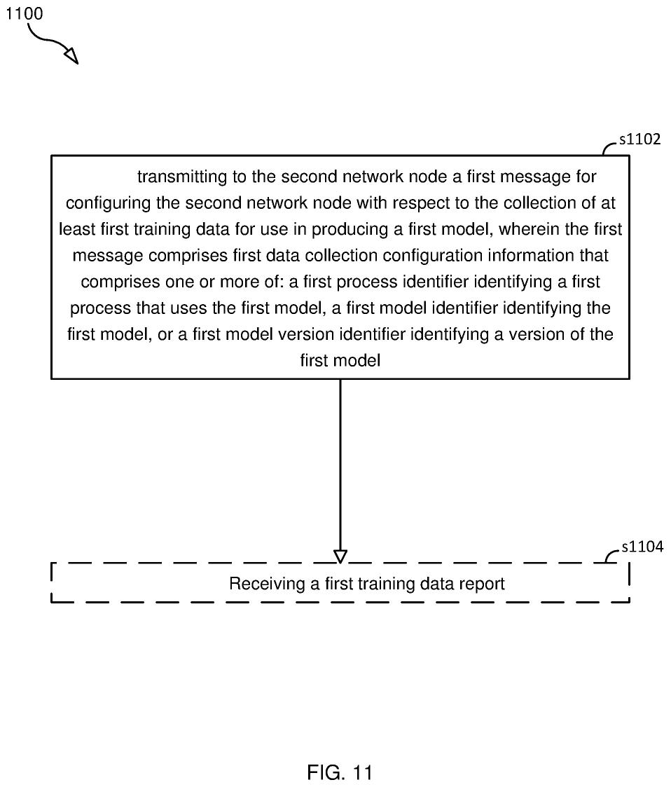

A1. A method 1100 (see FIG. 11) performed by a first network node for configuring a second network node, the method comprising: transmitting (see step s1102 in FIG. 11) to the second network node a first message for configuring the second network node with respect to collection of at least first training data for use in training a first model, wherein the first message comprises first data collection configuration information that comprises (i.e., includes at least) one or more of: a first process identifier identifying a first process (e.g., link adaptation process, power control process, etc.) that uses the first model (e.g. neural network or other model), a first model identifier identifying the first model, or a first model version identifier identifying a version of the first model.

A2. The method of embodiment A1, wherein the first data collection configuration information further comprises one or more of: a first cell identifier identifying a first cell of a radio access network (RAN) to which the first message should be applied; a second network node identities indicating the second node to which the configuration is addressed; an inference function identity to which the configuration is associated to or for which training data collection is configured or required; an actor identity indicating an actor to which the configuration is associated or for which training data collection is configured or required; and/or a rollout worker identity indicating a rollout worker to which the configuration is associated to or for which training data collection is configured or required.

A3. The method of embodiment A1 or A2, wherein the first data collection configuration information further comprises one or more of the following: the model; an indication of an exploration strategy to be used for the collection of the first training data; or one or more configuration parameters associated to an exploration strategy to be used for the collection of the first training data.

A4. The method of embodiment A1, A2, or A3, wherein the first data collection configuration information further comprises one or more of: a starting time indicator indicating a time at which the collection of the first training data should begin; an ending time indicator indicating a time at which the collection of the first training data should end; a time duration indicator indicating a period of time during which the collection of the first training data should occur; a repetition pattern indicator indicating a repetition pattern for the collection of the first training data; a periodicity indicator for indicating a periodicity for the collection of the first training data; at least one triggering condition indicator indicating a triggering condition to be fulfilled for initiating the collection of the first training data; or at least one triggering condition indicator indicating a triggering condition to be fulfilled for terminating the collection of the first training data.

A5. The method of any one of embodiments A1-A4, wherein the first data collection configuration information further comprises a first triggering condition indicator indicating a first triggering condition to be fulfilled for initiating the collection of the first training data, and the first triggering condition is at least one of: detection of a new network deployment; detection of a change in a key performance indicator, where the magnitude of the change exceeds a threshold; or detection of a learning metric satisfying a condition.

A6. The method of any one of embodiments A1-A5, wherein the first data collection configuration information further comprises one or more of: information indicating a number N of training data samples to be collected, information indicating a minimum number Nₘᵢₙ of training data samples to be collected, information indicating a maximum number Nₘₐₓ of training data samples to be collected, information indicating a number Ne of training data episodes, wherein each training data episode consists of multiple training data samples, information indicating a minimum number N_{e,min} of training data episodes to be collected, or information indicating a maximum number N_{e,max} of training data episodes to be collected.

A7. The method of any one of embodiments A1-A6, wherein the first data collection configuration information further comprises: first time interval information indicating a first interval of time during which the second network node is requested to collect at least training data associated to the use of the first process; and/or second time interval information indicating a second interval of time during which the second network node is requested to not to collect any training data associated to the use of the first process.

A8. The method of any one of embodiments A1-A7, wherein the first data collection configuration information further comprises: time interval information indicating an interval of time; and an indication that enables training data collection associated to the first process or the first model in the time interval.

A9. The method of any one of embodiments A1-A7, wherein the first data collection configuration information further comprises: time interval information indicating an interval of time; and an indication that disables training data collection associated to the first process or the first model in the time interval.

A10. The method of any one of embodiments A1-A9, wherein the first data collection configuration information further comprises reporting configuration information indicating a configuration for reporting collected first training data.

A11. The method of embodiment A10, wherein the reporting configuration information comprises a network node identifier identifying a network node to which a first training data report should be provided, wherein the identified network node is the first network node or a third network node.

A12. The method of embodiment A11, wherein the reporting configuration information comprises a network node identifier identifying the third network node, and the third network node comprises a shared memory storage for storing training data from multiple network nodes.

A13. The method of any one of embodiments A10-A12, wherein the reporting configuration information comprises one or more of: a reporting type identifier indicating a type of reporting (e.g., periodic reporting, one-time reporting, event-based or event-triggered reporting); start time information indicating a starting time to initiate reporting of the first training data; information indicating a maximum number of training data samples to be reported for each reporting instance; information indicating a minimum number of training data samples to be reported in each reporting instance.

A14. The method of any one of embodiments A10-A13, wherein the reporting configuration information comprises at least one report triggering condition indicator indicating a triggering condition to be fulfilled for initiating the reporting of the first training data.

A15. The method of embodiment A14, wherein the report triggering condition indicator indicates one or more of: a maximum number of training data samples collected, a minimum number of training data samples collected, a maximum waiting time for reporting training data.

A16. The method of any one of embodiments A1-A15, further comprising receiving (see step s1104 in FIG. 11) a first training data report transmitted by the second network node, wherein the first training data report is associated with the first model and comprises the first training data.

A17. The method of embodiment A14, wherein the first training data comprises a plurality of experience samples generated through use of the model.

A18. The method of embodiment A17, wherein each experience sample comprises: a first observation (e.g., an array of measured values); a selected action (e.g., a parameter value); a second observation obtained after the selected action is performed; and a reward value based at least on the second observation.

A19. The method of any one of embodiments A1-A18, wherein the first data collection configuration information indicates a first interval of time during which the second network node is to collect first training data for use in training the first model, the first message further comprises second data collection configuration information that comprises one or more of: i) a second process identifier identifying a second process, ii) a second model identifier identifying a second model, or iii) a second model version identifier identifying a version of the second model, the second data collection information indicates a second interval of time during which the second process should be activated and further indicates that the collection of first training data for use in training the first model should be disabled during the second interval of time.

A20. The method of embodiment A19, wherein the first data collection configuration information indicates a first interval of time during which the second network node is to collect first training data for use in training the first model, the first data collection configuration information further comprises one or more of: a second model identifier identifying a second model (e.g., a second version of the first model), the first data collection configuration information indicates a second interval of time during which the first process should use the second model instead of the first model and further indicates that the collection of first training data for use in training the first model should be disabled during the second interval of time.

A21. The method of embodiment A20, wherein the first data collection configuration information further indicates that: the first process should alternate between using first model and using the second model, collection of first training data should be activated while the first process is using the first model, and collection of first training data should be disabled while the first process is using the second model.

A22. The method of any one of embodiments A1-A21, wherein the first message is for further configuring the second network node with respect to the collection of training data for use in producing a third model, wherein the first message further comprises third data collection configuration information that comprises one or more of: a third process identifier identifying a third process that uses the third model, a third model identifier identifying the second model, or a third model version identifier identifying a version of the second model.

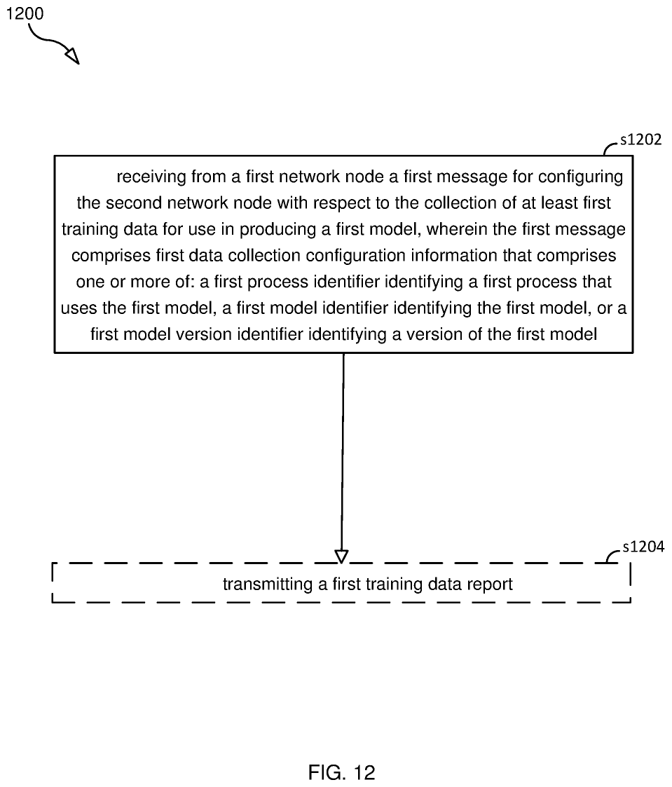

B1. A method 1200 (see FIG. 12) performed by a second network node, the method comprising: receiving (see step s1202 in FIG. 12) from a first network node a first message for configuring the second network node with respect to the collection of at least first training data for use in training a first model, wherein the first message comprises first data collection configuration information that comprises (i.e., includes at least) one or more of: a first process identifier (e.g., link adaptation or power control) identifying a first process that uses the first model (e.g., a neural network or other model), a first model identifier identifying the first model, or a first model version identifier identifying a version of the first model.

B2. The method of embodiment B1, wherein the first data collection configuration information further comprises a first cell identifier identifying a first cell of a radio access network (RBN) to which the first message should be applied.

B3. The method of embodiment B1 or B2, wherein the first data collection configuration information further comprises one or more of the following: the model; an indication of an exploration strategy to be used for the collection of the first training data; or one or more configuration parameters associated to an exploration strategy to be used for the collection of the first training data.

B4. The method of embodiment B1, B2, or B3, wherein the first data collection configuration information further comprises one or more of: a starting time indicator indicating a time at which the collection of the first training data should begin; an ending time indicator indicating a time at which the collection of the first training data should end; a time duration indicator indicating a period of time during which the collection of the first training data should occur; a repetition pattern indicator indicating a repetition pattern for the collection of the first training data; a periodicity indicator for indicating a periodicity for the collection of the first training data; at least one triggering condition indicator indicating a triggering condition to be fulfilled for initiating the collection of the first training data; or at least one triggering condition indicator indicating a triggering condition to be fulfilled for terminating the collection of the first training data.

B5. The method of any one of embodiments B1-B4, wherein the first data collection configuration information further comprises a first triggering condition indicator indicating a first triggering condition to be fulfilled for initiating the collection of the first training data, and the first triggering condition is at least one of: detection of a new network deployment; detection of a change in a key performance indicator, where the magnitude of the change exceeds a threshold; or detection of a learning metric satisfying a condition.

B6. The method of any one of embodiments B1-B5, wherein the first data collection configuration information further comprises one or more of: information indicating a number N of training data samples to be collected, information indicating a minimum number Nₘᵢₙ of training data samples to be collected, information indicating a maximum number Nₘₐₓ of training data samples to be collected, information indicating a number Ne of training data episodes, wherein each training data episode consists of multiple training data samples, information indicating a minimum number N_{e,min} of training data episodes to be collected, or information indicating a maximum number N_{e,max} of training data episodes to be collected.

B7. The method of any one of embodiments B1-B6, wherein the first data collection configuration information further comprises reporting configuration information indicating a configuration for reporting collected first training data.

B8. The method of embodiment B7, wherein the reporting configuration information comprises a network node identifier identifying a network node to which a first training data report should be provided, wherein the identified network node is the first network node or a third network node.

B9. The method of embodiment B8, wherein the reporting configuration information comprises a network node identifier identifying the third network node, and the third network node comprises a shared memory storage for storing training data from multiple network nodes.

B10. The method of any one of embodiments B7-B9, wherein the reporting configuration information comprises one or more of: a reporting type identifier indicating a type of reporting (e.g., periodic reporting, one-time reporting, event-based or event-triggered reporting); start time information indicating a starting time to initiate reporting of the first training data; information indicating a maximum number of training data samples to be reported for each reporting instance; information indicating a minimum number of training data samples to be reported in each reporting instance.

B11. The method of any one of embodiments B7-B10, wherein the reporting configuration information comprises at least one report triggering condition indicator indicating a triggering condition to be fulfilled for initiating the reporting of the first training data.

B12. The method of embodiment B11, wherein the report triggering condition indicator indicates one or more of: a maximum number of training data samples collected, a minimum number of training data samples collected, a maximum waiting time for reporting training data.

B13. The method of any one of embodiments B1-B12, further comprising transmitting (see step s1204 in FIG. 12) a first training data report to the first network node or a third network node, wherein the first training data report is associated with the first model and comprises the first training data.

B14. The method of embodiment B13, wherein the first training data comprises a plurality of experience samples generated through use of the model.

B15. The method of embodiment B14, wherein each experience sample comprises: a first observation; a selected action; a second observation obtained after the selected action is performed; and a reward value based at least on the second observation.

B16. The method of any one of embodiments B1-B15, wherein the first data collection configuration information further comprises: first time interval information indicating a first interval of time during which the second network node is requested to collect at least training data associated to the use of the first process; and/or second time interval information indicating a second interval of time during which the second network node is requested to not to collect any training data associated to the use of the first process.

B17. The method of any one of embodiments B1-B16, wherein the first data collection configuration information further comprises: time interval information indicating an interval of time; and an indication that enables training data collection associated to the first process or the first model in the time interval.

B18. The method of any one of embodiments B1-B16, wherein the first data collection configuration information further comprises: time interval information indicating an interval of time; and an indication that disables training data collection associated to the first process or the first model in the time interval.

B19. The method of any one of embodiments B1-B18, wherein the first data collection configuration information indicates a first interval of time during which the second network node is to collect first training data for use in training the first model, the first message further comprises second data collection configuration information that comprises one or more of: i) a second process identifier identifying a second process, ii) a second model identifier identifying a second model, or iii) a second model version identifier identifying a version of the second model, the second data collection information indicates a second interval of time during which the second process should be activated and further indicates that the collection of first training data for use in training the first model should be disabled during the second interval of time.

B20. The method of embodiment B19, wherein the first data collection configuration information indicates a first interval of time during which the second network node is to collect first training data for use in training the first model, the first data collection configuration information further comprises one or more of: a second model identifier identifying a second model (e.g., a second version of the first model), the first data collection configuration information indicates a second interval of time during which the first process should use the second model instead of the first model and further indicates that the collection of first training data for use in training the first model should be disabled during the second interval of time.

B21. The method of embodiment B20, wherein the first data collection configuration information further indicates that: the first process should alternate between using first model and using the second model, collection of first training data should be activated while the first process is using the first model, and collection of first training data should be disabled while the first process is using the second model.

B22. The method of any one of embodiments B1-B21, wherein the first message is for further configuring the second network node with respect to the collection of training data for use in producing a third model, wherein the first message further comprises third data collection configuration information that comprises one or more of: a third process identifier identifying a third process that uses the third model, a third model identifier identifying the second model, or a third model version identifier identifying a version of the second model.

B23. The method of any one of embodiments B1-B22, wherein the second network node is a user equipment

C1. A computer program (1343) comprising instructions (1344) which when executed by processing circuitry (1302) of a network node (1300) causes the network to perform the method of any one of embodiments A1-A22 or B1-B22.

C2. A carrier containing the computer program of claim C1, wherein the carrier is one of an electronic signal, an optical signal, a radio signal, and a computer readable storage medium (1342).

D1. A first network node, the first network node being configured to: . transmit (s1102) to a second network node a first message for configuring the second network node with respect to the collection of at least first training data for use in producing (e.g., generating or updating) a first model, wherein the first message comprises first data collection configuration information that comprises (i.e., includes at least) one or more of: a first process identifier (e.g., link adaptation or power control) identifying a first process that uses the first model (e.g. a neural network or other model), a first model identifier identifying the first model, or a first model version identifier identifying a version of the first model

D2. The first network node of embodiment D1, wherein the first network node is further configured to perform the method of any one of embodiments A2-A22.

E1. A second network node, the second network node being configured to: receive (s1202) from a first network node a first message for configuring the second network node with respect to the collection of at least first training data for use in producing a first model, wherein the first message comprises first data collection configuration information that comprises one or more of: a first process identifier identifying a first process that uses the first model, a first model identifier identifying the first model, or a first model version identifier identifying a version of the first model.

E2. The second network node of embodiment E1, wherein the second network node is further configured to perform the method of any one of embodiments B2-B22.

The term “transmit to” means “transmit directly or indirectly to.” Accordingly, transmitting a message to a node encompasses transmitting the message directly to the node or transmitting the message indirectly to the node such that the message is relayed to the node via one or more intermediate nodes. Similarly, the term “receive from” means “receive directly or indirectly from.” Accordingly, receiving a message from a node encompasses receiving the message directly from the node or receiving the message indirectly from node such that the message is relayed from the sender to the node via one or more intermediate nodes.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.
1-51. (canceled)

52. A method performed by a first network node for configuring a second network node, the method comprising:
transmitting to the second network node a first message for configuring the second network node with respect to collection of at least first training data for use in training a first model, wherein the first message comprises first data collection configuration information that comprises:
a first process identifier identifying a first process that uses the first model,
a first model identifier identifying the first model, and/or
a first model version identifier identifying a version of the first model.

53. The method of claim 52, wherein the first data collection configuration information further comprises:
a first cell identifier identifying a first cell of a radio access network, RAN, to which the first message should be applied;
a second network node identities indicating the second node to which the configuration is addressed;
an inference function identity to which the configuration is associated to or for which training data collection is configured or required;
an actor identity indicating an actor to which the configuration is associated or for which training data collection is configured or required;
a rollout worker identity indicating a rollout worker to which the configuration is associated to or for which training data collection is configured or required;
the model;
an indication of an exploration strategy to be used for the collection of the first training data;
a configuration parameter associated to an exploration strategy to be used for the collection of the first training data;.
a starting time indicator indicating a time at which the collection of the first training data should begin;
an ending time indicator indicating a time at which the collection of the first training data should end;
a time duration indicator indicating a period of time during which the collection of the first training data should occur;
a repetition pattern indicator indicating a repetition pattern for the collection of the first training data;
a periodicity indicator for indicating a periodicity for the collection of the first training data;
at least one triggering condition indicator indicating a triggering condition to be fulfilled for initiating the collection of the first training data; and/or
at least one triggering condition indicator indicating a triggering condition to be fulfilled for terminating the collection of the first training data.

54. The method of claim 52, wherein
the first data collection configuration information further comprises a first triggering condition indicator indicating a first triggering condition to be fulfilled for initiating the collection of the first training data, and
the first triggering condition is at least one of:
detection of a new network deployment;
detection of a change in a key performance indicator, where the magnitude of the change exceeds a threshold; or
detection of a learning metric satisfying a condition.

55. The method of claim 52, wherein the first data collection configuration information further comprises:
information indicating a number of training data samples to be collected;
information indicating a minimum number of training data samples to be collected;
information indicating a maximum number of training data samples to be collected;
information indicating a number of training data episodes, wherein each training data episode consists of multiple training data samples;
information indicating a minimum number of training data episodes to be collected; and/or
information indicating a maximum number of training data episodes to be collected.

56. The method of claim 52, wherein the first data collection configuration information further comprises:
first time interval information indicating a first interval of time during which the second network node is requested to collect at least training data associated to the use of the first process;
second time interval information indicating a second interval of time during which the second network node is requested to not to collect any training data associated to the use of the first process; and/or
time interval information indicating an interval of time and an indication that enables training data collection associated to the first process or the first model in the time interval; or time interval information indicating an interval of time and an indication that disables training data collection associated to the first process or the first model in the time interval.

57. The method of claim 52, wherein the first data collection configuration information further comprises reporting configuration information indicating a configuration for reporting collected first training data.

58. The method of claim 57, wherein the reporting configuration information comprises:
a reporting type identifier indicating a type of reporting;
start time information indicating a starting time to initiate reporting of the first training data;
information indicating a maximum number of training data samples to be reported for each reporting instance;
information indicating a minimum number of training data samples to be reported in each reporting instance; and/or
at least one reporting triggering condition indicator indicating a triggering condition to be fulfilled for initiating the reporting of the first training data.

59. The method of claim 52, wherein
the method further comprises receiving a first training data report transmitted by the second network node, and
the first training data report is associated with the first model and comprises the first training data.

60. The method of claim 52, wherein
the first data collection configuration information indicates a first interval of time during which the second network node is to collect first training data for use in training the first model,
the first message further comprises second data collection configuration information that comprises: i) a second process identifier identifying a second process, ii) a second model identifier identifying a second model, and/or iii) a second model version identifier identifying a version of the second model, and
the second data collection information indicates a second interval of time during which the second process should be activated and further indicates that the collection of first training data for use in training the first model should be disabled during the second interval of time.

61. The method of claim 52, wherein
the first message is for further configuring the second network node with respect to the collection of training data for use in producing a third model, and
the first message further comprises third data collection configuration information that comprises:
a third process identifier identifying a third process that uses the third model,
a third model identifier identifying the second model, and/or
a third model version identifier identifying a version of the second model.

62. A method performed by a second network node, the method comprising:
receiving from a first network node a first message for configuring the second network node with respect to the collection of at least first training data for use in training a first model, wherein the first message comprises first data collection configuration information that comprises:
a first process identifier identifying a first process that uses the first model,
a first model identifier identifying the first model, and/or
a first model version identifier identifying a version of the first model.

63. The method of claim 62, wherein the first data collection configuration information further comprises a first cell identifier identifying a first cell of a radio access network (RAN) to which the first message should be applied.

64. The method of claim 62, wherein the first data collection configuration information further comprises:
the model;
an indication of an exploration strategy to be used for the collection of the first training data;
a configuration parameter associated to an exploration strategy to be used for the collection of the first training data;
a starting time indicator indicating a time at which the collection of the first training data should begin;
an ending time indicator indicating a time at which the collection of the first training data should end;
a time duration indicator indicating a period of time during which the collection of the first training data should occur;
a repetition pattern indicator indicating a repetition pattern for the collection of the first training data;
a periodicity indicator for indicating a periodicity for the collection of the first training data;
at least one triggering condition indicator indicating a triggering condition to be fulfilled for initiating the collection of the first training data; and/or
at least one triggering condition indicator indicating a triggering condition to be fulfilled for terminating the collection of the first training data.

65. The method of claim 62, wherein the first data collection configuration information further comprises a first triggering condition indicator indicating a first triggering condition to be fulfilled for initiating the collection of the first training data, and the first triggering condition is at least one of:
detection of a new network deployment;
detection of a change in a key performance indicator, where the magnitude of the change exceeds a threshold; or
detection of a learning metric satisfying a condition.

66. The method of claim 62, wherein the first data collection configuration information further comprises:
information indicating a number of training data samples to be collected;
information indicating a minimum number of training data samples to be collected;
information indicating a maximum number of training data samples to be collected;
information indicating a number of training data episodes, wherein each training data episode consists of multiple training data samples;
information indicating a minimum number of training data episodes to be collected;
information indicating a maximum number of training data episodes to be collected; or
reporting configuration information indicating a configuration for reporting collected first training data.

67. The method of claim 66, wherein the reporting configuration information comprises:
a reporting type identifier indicating a type of reporting;
start time information indicating a starting time to initiate reporting of the first training data;
information indicating a maximum number of training data samples to be reported for each reporting instance;
information indicating a minimum number of training data samples to be reported in each reporting instance; and/or
at least one report triggering condition indicator indicating a triggering condition to be fulfilled for initiating the reporting of the first training data.

68. The method of claim 62, wherein
the method further comprises transmitting a first training data report to the first network node or a third network node, and
the first training data report is associated with the first model and comprises the first training data.

69. The method of claim 62, wherein the first data collection configuration information further comprises:
first time interval information indicating a first interval of time during which the second network node is requested to collect at least training data associated to the use of the first process;
second time interval information indicating a second interval of time during which the second network node is requested to not to collect any training data associated to the use of the first process; and/or
time interval information indicating an interval of time and an indication that enables training data collection associated to the first process or the first model in the time interval; or time interval information indicating an interval of time and an indication that disables training data collection associated to the first process or the first model in the time interval.

70. A first network node, the first network node comprising:
a transmitter; and
processing circuitry, wherein the first network node is configured to:
use the transmitter to transmit to a second network node a first message for configuring the second network node with respect to the collection of at least first training data for use in producing a first model, wherein the first message comprises first data collection configuration information that comprises:
a first process identifier identifying a first process that uses the first model,
a first model identifier identifying the first model, and/or
a first model version identifier identifying a version of the first model.

71. A second network node, the second network node comprising:
processing circuitry; and
a receiver for receiving a first message comprising first data collection configuration information that comprises:
a first process identifier identifying a first process configured to use a first model,
a first model identifier identifying the first model, and/or
a first model version identifier identifying a version of the first model, and
the second network node is configured to use the first data collection configuration information to configure itself with respect to the collection of at least first training data for use in producing the first model.
